(19) United States
(12) Patent Application Publication
(10) Pub. No.: US 2019/0039033 A1
(43) Pub. Date: Feb. 7, 2019

(54) FOOD MACHINE FOR PREPARING ALIGOT

(71) Applicant: CARRIVAL, Almont les Junies (FR)

(72) Inventors: Fabrice CARRIER, Flagnac (FR); Christian VALETTE, Paris (FR)

(73) Assignee: CARRIVAL, Almont les Junies (FR)

(21) Appl. No.: 16/076,615

(22) PCT Filed: Feb. 6, 2017
(86) PCT No.: PCT/FR2017/050265

§ 371 Date: Aug. 8, 2018

(30) Foreign Application Priority Data
Feb. 9, 2016 (FR) 1651026

(51) Int. Cl. B01F 7/08; B01F 15/02; B01F 7/04

(52) U.S. Cl. CPC B01F 7/085; B01F 15/027; B01F 2015/00642; B01F 7/082; B01F 7/086; B01F 7/042

(57) ABSTRACT

A mixing device for preparing aligot, including a mixing case containing a chamber that opens at an inlet for conveying material to be mixed, and a mixing member, where the mixing member includes at least one roller that is mounted rotating on a motorised shaft, one or more bearing surfaces of the roller being designed to engage in a crushing manner with the surfaces of the chamber of the case.

### CROSS REFERENCE TO RELATED APPLICATIONS

This application is the National Stage of International Application No. PCT/FR2017/050265, having an International Filing Date of 6 Feb. 2017, which designated the United States of America, and which International Application was published under PCT Article 21(2) as WO Publication No. 2017/137686 A1, which claims priority from and the benefit of French Patent Application No. 1651026, filed on 9 Feb. 2016, the disclosure of which are incorporated herein by reference in their entireties.

### BACKGROUND

### 1. Field

This disclosed embodiment relates to the field of food preparation machines and relates to, in particular, a machine for preparing instant cooked portions. The disclosed embodiment more particularly relates to machines intended for use in the catering trade for preparing fully ready-to-eat foods, and relates even more particularly to quick-serve restaurants.

### 2. Brief Description of Related Developments

The preservation of food, in particular in the form of ready-made dishes, is a sensitive sector in the food processing industry. Although most foods can be preserved for consumption at a later stage, the storage of certain foods remains problematic.

The use of preservatives, recourse to freezing, sonication, ionisation, freeze-drying, etc. are not always compatible with the food to be preserved, and very often modify the gustatory and/or organoleptic properties of the foods. This is the case with complex mixtures, such as for example certain ready-made dishes, which are comprised of a plurality of ingredients that have to be able to be conditioned, then prepared at the moment of consumption by remaining as close as possible to the taste and the texture of the original recipe.

In the framework of food machines that instantly distribute portions according to need, such as the ice cream distributors used in the catering industry, the rheology of the foods is a preponderant factor that has to be taken into consideration. This rheology, which is in particular conditioned by the very nature of each ingredient, is sensitive to the temperature, which makes it complicated to distribute ready-made dishes prepared using a mixture of several ingredients.

Potato aligot is a dish that is substantially prepared from the potato, tome (cheese), water and optionally fresh cream and/or milk. Although the preservation of such aligot is known in application FR 2 537 403 which describes a conditioning in the form of frozen granules, the automated preparation of a dish that faithfully restores the gustatory, and even organoleptic, properties of the original recipe is a difficult task.

Furthermore, although devices for the automated processing of food which require a blending, even a mixing, are known, such as for example the devices described in application EP 2 572 584, their structure and their operating mode are unsuitable for the preparation of thick and sticky ready-made dishes, such as aligot, which would quickly render them unusable mainly due to the clogging of the ducts and of the mixing members of said distributors.

### SUMMARY

The disclosed embodiment aims to resolve the disadvantages of the aforementioned prior art.

To this effect, this disclosed embodiment relates to a mixing device, also referred to as “mixer”, for preparing aligot, comprising a mixing case, containing a chamber that opens at an inlet for conveying material to be mixed, and a mixing member, characterised in that said mixing member comprises at least one roller that is mounted rotating on a motorised shaft, one or more bearing surfaces of the roller being designed to engage in a crushing manner with the surfaces of said chamber of the case. The motorised shaft can, for example, be driven by a motor of the “brushless” type—i.e. a motor without brushes that operates with direct current—or an asynchronous motor, that can develop up to 1,500 kW (4P).

Engaging in a crushing manner means, in the framework of the disclosed embodiment, that the surfaces press against one another, or that there is a space that remains substantially constant between two surfaces intended to be engaged during the rotation movement of the rollers. Such a space between the rollers is ideally from 0.2 to 0.4 mm. Such an engaging between the roller and the surface of the case allows for an optimised spinning of the aligot in order to obtain a consistency that is indeed stringy and homogeneous.

Preferably, the mixing member comprises at least two rollers, a first roller and a second roller. Such a configuration allows for an engaging between at least two rollers integrated into the mixing member is perfectly compatible with sticky food products such as the ingredients that are part of the preparation of potato aligot. The two rollers operate in synergy in order to stretch the material as much as possible. These rollers operate as blades and are further suitable for aligot compared to blades mounted on the rods, of the endless screw type, which are provided on mixer-extruders of prior art.

The bearing surfaces extend substantially radially on the surface of the rollers. The number of bearing surfaces of each roller of the mixing member is not limited. Advantageously, each roller comprises two bearing surfaces which extend substantially radially on their surface with respect to their axis of rotation, and the rollers substantially preferably have a fusiform shape as a cross-section. The fusiform shape makes it possible to give the rollers a profile in such a way that they are continuously in contact with the material during the entire mixing.

Each one of said bearing surfaces is advantageously at least one helicoid portion. Such a helicoidal conformation provides a close engaging of the different surfaces on the food material to be processed, while still making it possible to flush the mixed material towards a wall of the case of the mixing device. As such the profile of the rollers is designed so that all of the surfaces of the material to be mixed are swept by the rotation movement. Furthermore, tests conducted with rollers with a straight profile (not helicoidal) have established that the mixing is not effective, that there are obstruction phenomena, that the material is not correctly directed to the outlet of the chamber of the mixer, and the pasty products are not removed.

Advantageously, the rollers are mounted on shafts designed to be rotated in the same direction. Such a configuration of the system comprised of rollers and of their axis provides optimum flow of the mixed material. The rotation is for example carried out in the clockwise direction of rotation of the helicoidal rollers, in such a way as to return the product to be mixed on a heating system, for example on the hottest part of said system, as such providing a faster heating of the product.

More advantageously, the shafts are designed to rotate simultaneously in both directions, in a clockwise direction and in an anti-clockwise direction. Thanks to this configuration, it is possible to trigger the rotation in a first direction in order to favour the mixing in the chamber of the mixer, and once this operation is carried out proceed with emptying the chamber by reversing the direction of rotation of the rollers, qualified as the second direction.

Advantageously, the mixing device comprises a heating system that comprises at least one resistance from 150 to 250 W, such a system is ideally provided for bringing a mixture of aligot to a temperature from 65 to 75° C.

Advantageously, the chamber of the mixer and/or the mixing member comprise a non-stick coating, preferably polytetrafluoroethylene (PTFE). As such when the food materials are heated in the mixer they do not stick to the walls and can more easily be mixed, then removed.

Advantageously, the mixing case comprises a retractable cover controlled by a control lever. Such a cover allows for a facilitated expulsion of the mixed aligot directly to the front, which is easier than an expulsion from underneath directly facing downwards.

The number of rollers of the mixing member of the machine according to the invention is not limited, in order to accentuate the mixing, the mixing member advantageously contains three rollers, even more than three rollers. These rollers can be placed in series, with their axes of rotation positioned in parallel, in the same plane. These rollers can also be positioned in such a way that a bearing surface of the same roller engages with bearing surfaces of different rollers. The presence of three rollers or more is advantageous for food mixtures that are particularly thick and sticky.

According to another aspect the disclosed embodiment also relates to a food machine for preparing aligot, comprising a hopper intended to contain ingredients of a preparation of aligot, a mixing device such as described hereinabove positioned downstream of the hopper and a metering system mounted at the output of the hopper and downstream of said mixing device. The food machine comprises a metering system, also qualified as a “dosing device”, mounted at the outlet of the hopper and downstream of said mixing device, and designed to meter a portion of the aligot preparation. In this way, calibrated portions ready for consumption are obtained at the outlet. Preferably, the prepared portions are from 100 to 300 g. The metering system can be carried out by a mechanism for conveying aligot granulate from the refrigeration unit box comprising an endless screw.

Advantageously, this food machine comprises a refrigeration unit box integrating the hopper and suitable for the storage of frozen granules of aligot. In this way, it is possible to use granules such as those described in the aforementioned application, FR 2 537 403, as an ingredient during the manufacture of the aligot. Such a machine allows for the storage of a reserve of frozen product, conditioned for example at −18° C., then the preparing and the heating of portions of aligot directly in the plate.

The food machine according to the disclosed embodiment preferably comprises a metering system for a predetermined quantity of water which is connected to the chamber of the mixing device, such as a bistable solenoid valve.

This also relates to a method for preparing an aligot on demand that implements the use of the food machine according to the disclosed embodiment, and that comprises a first step of pouring into the mixing device a determined quantity of frozen aligot granules, from the hopper. This step is advantageously carried out by a metering system with an endless screw of the food machine positioned at the outlet of the hopper. The method comprises a second step of hydration of the granulates in the mixing device by the adding of a determined quantity of water. This step is carried out advantageously by a bistable solenoid valve of the food machine mounted on the mixing device. The method comprises a third step of mixing consisting in heating at least one wall of the chamber of the mixer and in maintaining the rotation of the at least one roller in a first direction of rotation, for example in the clockwise direction. The method also comprises a fourth step of emptying the mixing device consisting in provoking the rotation of the at least one roller in a second direction of rotation, for example in the anti-clockwise direction.

### BRIEF DESCRIPTION OF THE DRAWINGS

Other characteristics and advantages of the disclosed embodiment shall appear when reading the following detailed, based on the accompanying drawings. These examples are provided in a non-limiting way. The detailed description is to be read with regards to the accompanying drawings wherein:

FIG. 1 shows an embodiment of the food machine according to the invention;

FIG. 2 shows as an exploded configuration the same embodiment as that of FIG. 1;

FIG. 3 shows the hopper in the refrigeration unit box on the left, and without the refrigeration unit box on the right;

FIG. 4 shows a perspective view of the mixing device of the food machine shown in FIGS. 1 and 2;

FIG. 5 shows another perspective view of the mixing device of FIG. 4;

FIG. 6 shows a front view of the control panel of the machine shown in FIGS. 1 and 2;

FIG. 7 shows an exploded view of the entire machine according to the disclosed embodiment;

FIG. 8 shows a front view of the first and second rollers mounted on their respective shaft; and

FIGS. 9 and 10 show a perspective view of the mixing case with its cover and the control lever; and

FIGS. 11 and 12 show a perspective view of the mixing case without its cover and the control lever.

### DETAILED DESCRIPTION

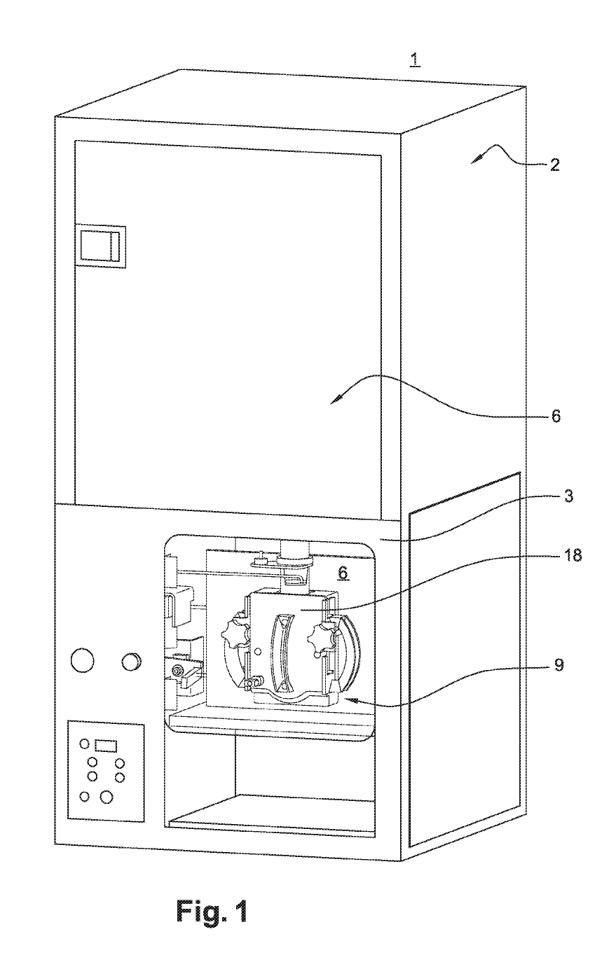

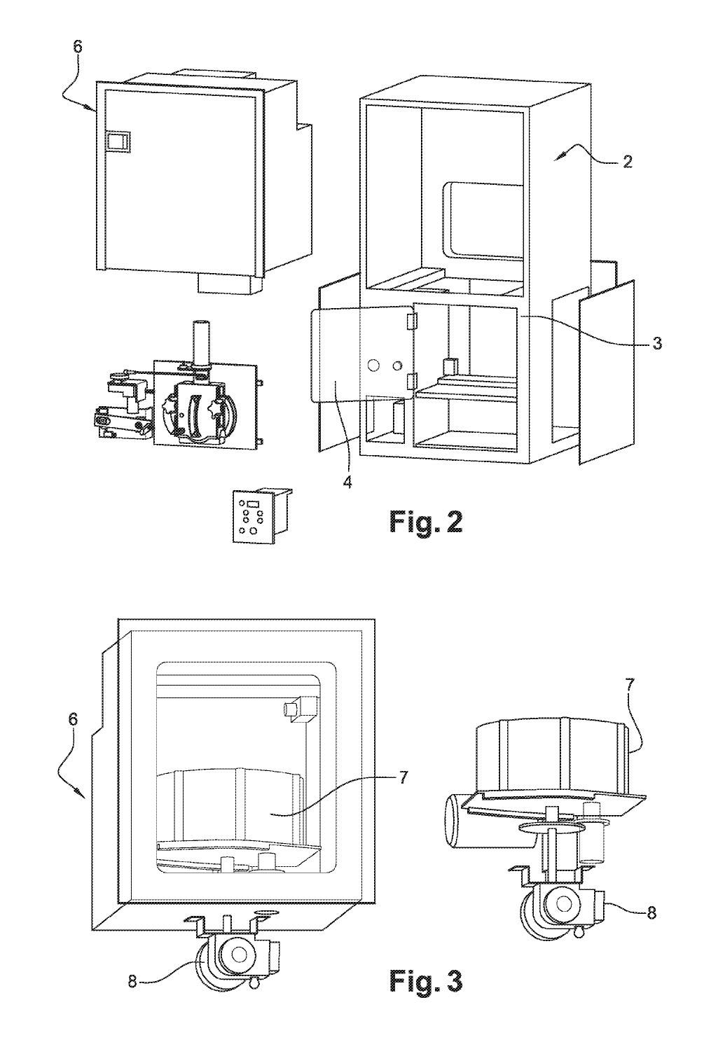

FIG. 1 shows an embodiment of a food machine 1 for preparing aligot comprising a metal casing a metal formwork 2 made of stainless steel comprising a façade 3. The façade 3 contains a cover 4 that can be seen in FIG. 2, and intended to close the space in front of a mixing device 5 of said food machine.

In the upper portion, the food machine comprises a refrigeration unit box 6 of 59 litres and a power of 180 Watts, which is provided with a door with mechanical coupling and is suitable for maintaining a constant cold of −18° C. The refrigeration unit box 6 contains a hopper 7 of 10 litres filled with 4 kg of frozen granules of aligot. The hopper 7 is connected to a metering system via endless screw 8 provided for metering a quantity of aligot granulate.

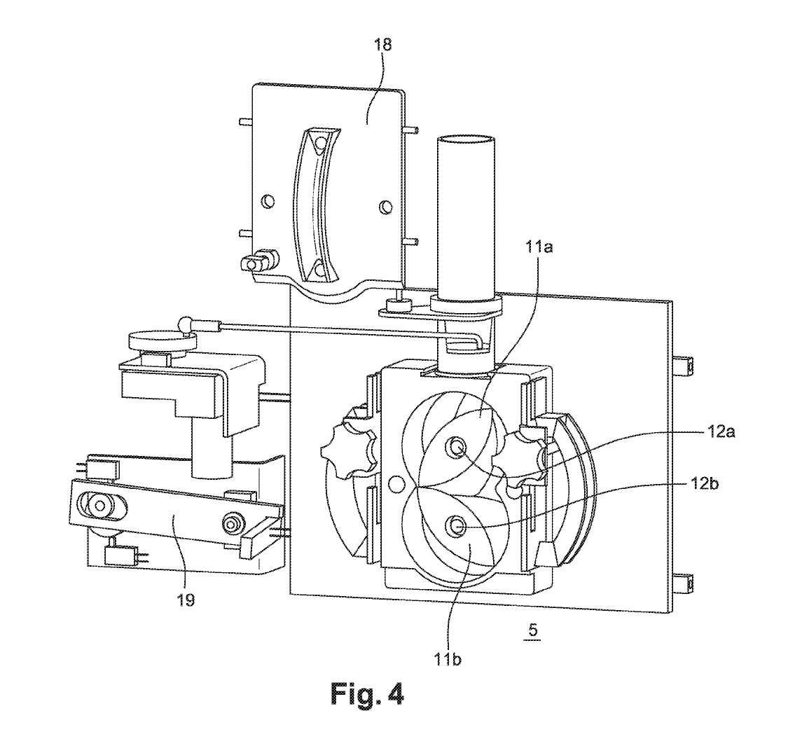

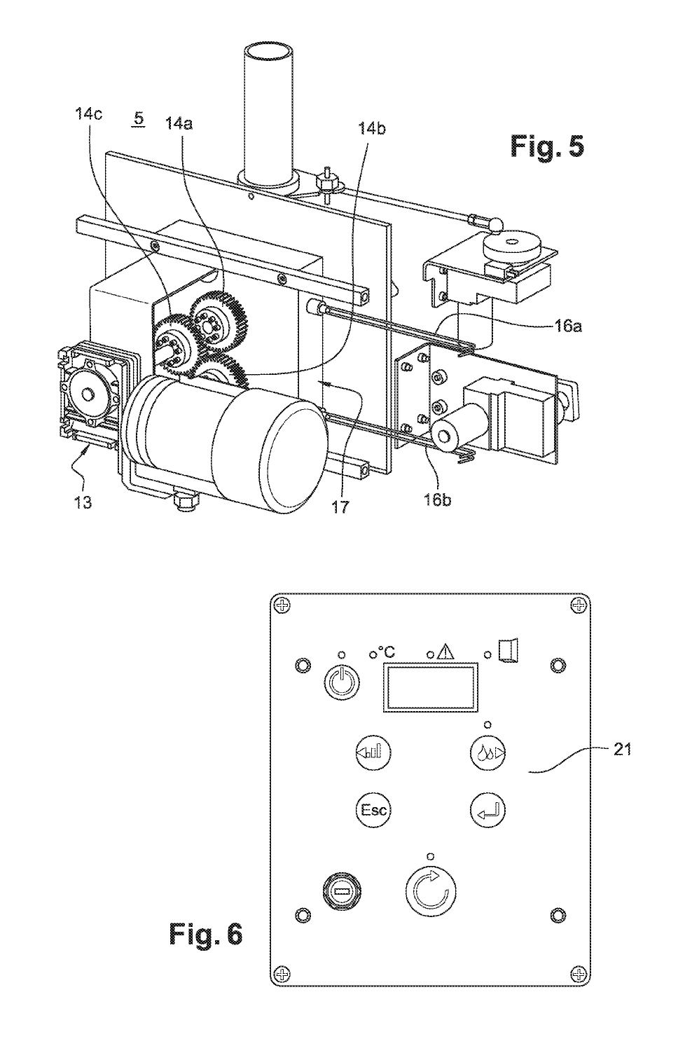

The mixing device 5 of which a detailed view is shown in FIG. 4 comprises a mixing case 9. The endless screw metering system 8 is connected onto the upper portion of the mixing case 9 of the mixing device 5 as shown in the FIGS. 4 and 5. On the mixing case 9 is also connected a mechanism for hydrating the granulate provided with a bistable solenoid valve which allows for the distribution of a predetermined quantity of water.

The mixing device 5 comprises a first roller 11a as well as a second roller 11b, the first roller 11a is mounted on a first shaft 12a and the second roller 11b is mounted on a second shaft 12b, and the two rollers are both integrated into the mixing case 9. The first roller 11a and the second roller 11b have a fusiform cross-section and helicoidal bearing surfaces (see FIG. 8). The outer surface of the rollers 11a and 11b is comprised of a self-cleaning material comprising a non-stick polymer, for example polytetrafluoroethylene (PTFE). In a preferred embodiment, the first and second shafts 12a and 12b are coupled to a motor 13 of 180 Watts which can be seen in FIG. 5, which shows the mixing device 5 that can be seen in FIG. 4 from another angle (seen from the rear in relation to FIG. 4). On the first and second shafts 12a and 12b are fastened respectively a first gear 14a and a second gear 14b, both coupled to a third gear 14c of a motor shaft 15, i.e. a shaft that is directly coupled, even connected, to the rotor of the motor 13. Thanks to this configuration shown in FIG. 5, turning on the motor 13 causes the rotation of the first and second rollers 11a and 11b in the same direction of rotation.

The mixing device 5, according to this detailed embodiment, comprises a heating system comprising two resistances 16a and 16b of 200 Watts each and which heat via the joule effect the portion of the mixing case 9 placed opposite the motor 13, and qualified as a rear zone 17 of the case. This heating system brings the aligot preparation to a temperature of 65 to 75° C. in a few minutes. The inner surfaces of the mixing case 9 are made from a self-cleaning material comprising a non-stick polymer, for example polytetrafluoroethylene (PTFE), in order to prevent the sticky food products from sticking to the walls. The mixing case 9 comprises on its front face a cover 18 that can be fastened by screwing onto the rest of the case. The cover 18 can be retracted, in the manner of a trap, in order to remove the product downwards as shown in FIG. 10.

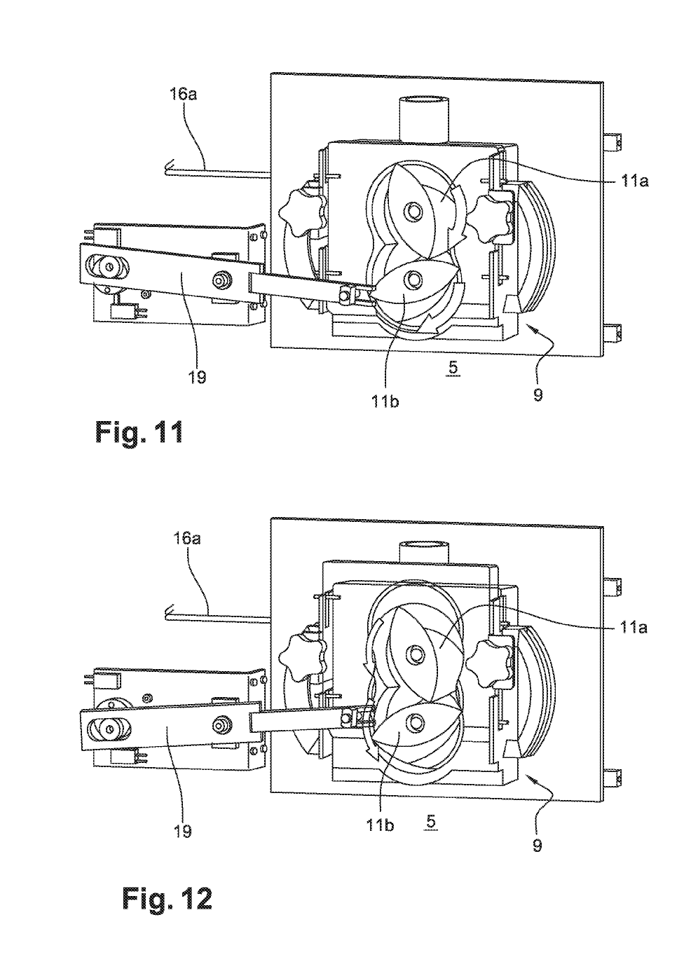

The operation of the mixing device 5 begins with the moving of the first and second rollers 11a and 11b, which are mobile in the same direction of rotation as seen hereinabove. The motor 13 is first of all actuated in such a way as to move the two rollers 11a and 11b in the clockwise direction, when they are observed from the front side of the case as shown in FIG. 11. The helicoidal conformation of the rollers 11a and 11b makes it possible to thrust the food products, i.e. in this case the aligot granulate poured from the hopper 7, onto the rear zone 17 of the mixing case 9. The profile of the rollers allows for the sweeping of the entire surface of the aligot. The rear zone 17 is heated by the two resistances 16a and 16b, which makes it possible to heat the product during the mixing. During this step the string of aligot can be formed in good conditions given that the product is continuously stretched and heated.

Once the product is hot enough (65 to 75° C.) and mixed, it must be poured outside of the mixer. For this purpose, the rotation of the motor 13 is actuated in the other direction, in such a way as to provoke the rotation of the rollers 11a and 11b in the anti-clockwise direction as shown in FIG. 12. The setting into rotation of the rollers 11a and 11b in the anti-clockwise directions drives the displacement of the aligot towards the front side of the mixer, i.e. that aligot is thrust against the cover 18 of the mixing case 9. The cover 18 is retracted synchronously with the operation in the anti-clockwise direction in order to make it possible to pour the aligot which is ready for consumption. A control lever 19 actuates the opening and the closing of the cover 18.

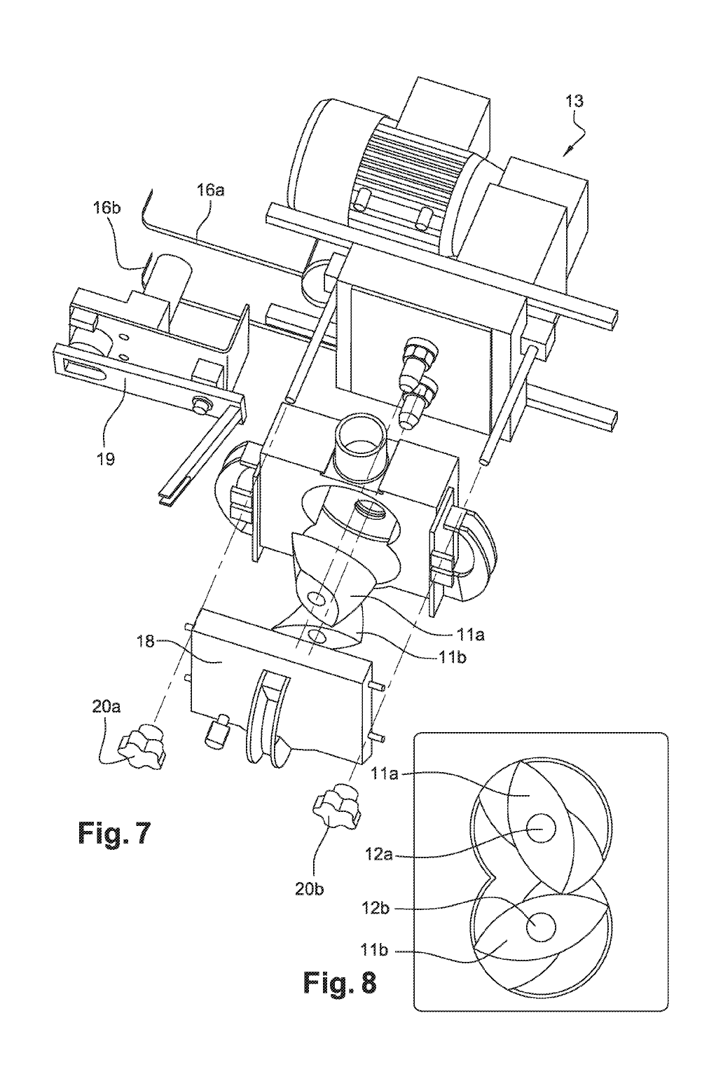

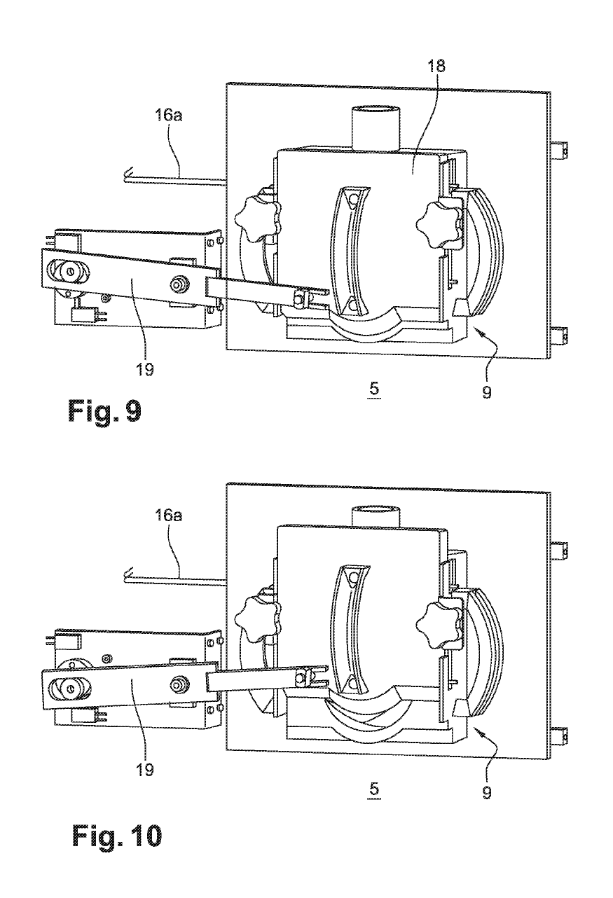

FIG. 7 shows an exploded view of the food machine 1 that can be disassembled easily, in particular thanks to the presence of two knurled knobs 20a and 20b mounted on the cover 18.

The user controls the operation of the food machine 1 for preparing aligot from the control panel 21, in order to obtain an aligot the is ready for consumption from frozen granulates of aligot. The granulates are first hydrated, then mixed and heated, in order to obtain an aligot preparation which is automatically removed outside of the food machine.

What is claimed is:

1. Mixing device for preparing aligot, comprising a mixing case containing a chamber that opens at an inlet for conveying material to be mixed, and a mixing member, where said mixing member comprises at least one roller that is mounted rotating on a motorised shaft, at least one bearing surface of the roller being designed to engage in a crushing manner with the surfaces of said chamber of the case.

2. Mixing device according to claim 1, wherein the mixing member comprises at least two rollers, a first roller and a second roller.

3. Mixing device according to claim 1, wherein the cross-section of said roller with respect to the axis of its motorised shaft is substantially substantially fusiform.

4. Mixing device according to claim 1, wherein said bearing surfaces are a portion of a helicoid.

5. Mixing device according to claim 2, wherein said rollers are mounted on shafts designed to be rotated in the same direction.

6. Mixing device according to claim 5, wherein said shafts are designed to rotate simultaneously in both directions, in a clockwise direction and in an anti-clockwise direction.

7. Mixing device according to claim 1, comprising a heating system comprising at least one resistance from 150 to 250 W.

8. Mixing device according to claim 1, wherein at least one of the elements selected from the chamber of the mixer and the mixing member comprise a non-stick coating.

9. Mixing device according to claim 1, wherein the mixing case comprises a retractable cover controlled by a control lever.

10. Food machine for preparing aligot, comprising a hopper intended to contain ingredients of a preparation of aligot, a mixing device according to claim 1 positioned downstream of the hopper and a metering system mounted at the output of the hopper and downstream of said mixing device.

11. Food machine according to claim 10, wherein said machine comprises a refrigeration unit box integrating the hopper, suitable for the storage of frozen granules of aligot.
